(19) United States
(12) Patent Application Publication
(10) Pub. No.: US 2026/0125279 A1
(43) Pub. Date: May 7, 2026

(54) METHOD FOR PREPARING HIGH-PURITY MIXED NICKEL AND COBALT SULPHATE

(71) Applicant: IGO Limited, South Perth (AU)

(72) Inventors: Christopher Brett Ward, South Fremantle (AU); Aaron Christopher White, Stirling (AU); Karel John Osten, North Perth (AU)

(73) Assignee: IGO Limited, South Perth (AU)

(21) Appl. No.: 19/119,022

(22) PCT Filed: Oct. 5, 2023
(86) PCT No.: PCT/AU2023/050967

§ 371 Date: Apr. 7, 2025

(30) Foreign Application Priority Data
Oct. 7, 2022 (AU) 2022902923
Oct. 17, 2022 (AU) 2022903049

(51) Int. Cl. C01G 53/10; C01G 51/10; C22B 3/00; C22B 3/08; C22B 3/26

(52) U.S. Cl. CPC C01G 53/10; C01G 51/10; C22B 3/08; C22B 3/26; C22B 23/043

(57) ABSTRACT

A method for preparing high-purity mixed nickel and cobalt sulphate, the method comprising the recovery of nickel and cobalt sulphate crystals from an organic phase rich in both nickel and cobalt by way of contacting the nickel and cobalt rich organic phase with an aqueous strip solution of sufficient H2SO4 concentration to extract nickel and cobalt from the organic phase and of sufficient Ni²⁺ and Co²⁺ concentration to precipitate nickel and cobalt sulphate crystals and form a nickel and cobalt lean organic phase. Also disclosed is a method for the optimisation of feed for downstream processing.

### FIELD OF THE INVENTION

The present invention relates to a method for preparing high-purity mixed nickel and cobalt sulphate.

Further, the present invention also relates to a high-purity mixed nickel and cobalt sulphate produced by this method.

### BACKGROUND ART

In the Applicant's previous International Patent Application PCT/AU2019/051044 (WO 2020/061639) there is described a method of recovering nickel sulphate hexahydrate (NiSO4·6H2O). It is described therein that the nickel sulphate hexahydrate should be high purity. By ‘high purity’ it is meant a nickel content of at least 21%, and preferably between 21 and 24% and most preferably around 22-23%, in the nickel sulphate hexahydrate. As would be understood by the skilled person this includes a nickel content of 22.0%, 22.1%, 22.2%, 22.3%, 22.4%, 22.5%, 22.6%, 22.7%, 22.8%, 22.9% and 23%, in the nickel sulphate hexahydrate. It is also meant that high purity/battery-grade nickel sulphate hexahydrate is also very low in trace metal element levels, including no more than 350 ppm Co, no more than 10 ppm Cu, no more than 25 ppm Ca, no more than 15 ppm Cr, no more than 15 ppm Fe, no more than 35 ppm Mg, no more than 15 ppm Mn, no more than 15 ppm Pb and no more than 15 ppm Zn. Preferably, high purity/battery-grade nickel sulphate hexahydrate includes no more than 250 ppm Co, no more than 5 ppm Cu, no more than 15 ppm Ca, no more than 10 ppm Cr, no more than 10 ppm Fe, no more than 25 ppm Mg, no more than 10 ppm Mn, no more than 10 ppm Pb and no more than 10 ppm Zn.

High purity nickel sulphate hexahydrate is an important source of nickel for use in advanced lithium-ion batteries. It is therefore also referred to as ‘battery-grade’ nickel sulphate, wherein battery-grade nickel sulphate has the same nickel sulphate hexahydrate content as detailed above for high purity nickel sulphate hexahydrate, and is used interchangeably.

In a first aspect of the invention described in the Applicant's previous International Patent Application PCT/AU2019/051044 (WO 2020/061639), the entire content of which is explicitly incorporated herein by reference, there is provided a method of recovering NiSO4·6H2O crystals from a nickel rich organic phase, the method including:
(i) contacting a nickel rich organic phase with an aqueous strip solution of sufficient H2SO4 concentration to extract nickel from the organic phase and of sufficient Ni2+ concentration to precipitate NiSO4·6H2O crystals and form a nickel lean organic phase.

The skilled person will appreciate that the concentration of H2SO4 and Ni2+ in the strip solution will vary depending on the particular conditions under which the method is carried out (e.g. temperature, pressure, presence of other ions).

In an embodiment, the strip solution has a Ni2+ concentration of 60 g/L or greater. More preferably, the strip solution has a Ni2+ concentration of 70 g/L or greater. Most preferably, the strip solution has a Ni2+ concentration of 80 g/L or greater. Additionally, or alternatively, the strip solution has a Ni2+ concentration of up to 100 g/L.

In an embodiment, the strip solution has an H2SO4 concentration of 300 g/L or greater, or 350 g/L or greater, or the strip solution has a H2SO4 concentration of from about 350 up to about 450 g/L.

In an alternative embodiment, the strip solution has an H2SO4 concentration of 300 g/L or less. Preferably, the strip solution has a H2SO4 concentration of 10-300 g/L.

In an embodiment, the strip solution has a SO4²⁻ and Ni²⁺ concentration that are together at or near the solubility limit of NiSO4·6H2O. By near the solubility limit it is meant that the concentration is such that at least 90 wt % of the nickel extracted from the organic phase is precipitated as NiSO4·6H2O. Preferably, 95 wt % of the nickel extracted from the organic phase is precipitated as NiSO4·6H2O. More preferably, 98 wt % of the nickel extracted from the organic phase is precipitated as NiSO4·6H2O. Most preferably, 99 wt % of the nickel extracted from the organic phase is precipitated as NiSO4·6H2O.

In an embodiment, the nickel rich organic phase is immiscible with water.

In an embodiment, the method further includes separating the NiSO4·6H2O crystals from the nickel lean organic phase.

In an embodiment, the nickel rich organic phase includes at least: nickel (such as in the form of Ni²⁺), an organic extractant, and an organic diluent.

Preferably, the nickel rich organic phase includes a coordination complex of nickel and an organic extractant, wherein the organic extractant dissociates from the nickel in the presence of a sufficient concentration of H+ ions (such as those derived from the dissociation of H2SO4). More preferably, the H+ ions are provided in an ion exchange process with the NiSO4.

In forms of the above embodiment, the organic extractant is selected from the group consisting of: organophosphorus acids, chelating oximes or hydroxyoximes, carboxylic acids, and high molecular weight amines (such as n-octylaniline, tri-octyl/decyl amine, tri-octylamine, tri-iso-octyamine, N-n-octylaniline, and 2-ethylhexyl amino methyl pyridine).

In forms of the above embodiment, the organic extractant is from about 10 wt % up to about 25 wt % of the organic phase. Preferably, the organic extractant is from about 12 wt % of the organic phase. More preferably, the organic extractant is from about 14 wt % of the organic phase. Alternatively, or additionally, the organic extractant is up to about 22 wt % of the organic phase. More preferably, the organic extractant is up to about 20 wt % of the organic phase. In one example, the organic extractant is about 18 wt % of the organic phase.

In forms of the above embodiment, the organic extractant is one or more branched carboxylic acids, such as a branched carboxylic acid having from 7 carbon atoms up to 15 carbon atoms. Preferably, the branched carboxylic acid has from 8 carbon atoms. Most preferably, the branched carboxylic acid has from 9 carbon atoms. Alternatively or additionally, the branched carboxylic acid has up to 14 carbon atoms. Preferably, the branched carboxylic acid has up to 13 carbon atoms. More preferably, the branched carboxylic acid has up to 12 carbon atoms. Most preferably, the branched carboxylic acid has up to 11 carbon atoms. In one form, the branched carboxylic acid has 10 carbon atoms.

In forms of the above embodiment, the organic extractant is a branched monocarboxylic acid.

In forms of the above embodiment, the organic extractant is a branched carboxylic acid of the structure:

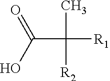

wherein R1 and R2 are branched or straight chain unsubstituted alkyl groups, and R1 and R2 together consist of from 5 to 13 carbon atoms.

Preferably, the branched carboxylic acid is a neodecanoic acid.

Neodecanoic acid is a mixture of carboxylic acids with the common structural formula C10H20O2. The term neodecanoic acid therefore encompasses compounds such as: 2,2,3,5-Tetramethylhexanoic acid, 2,4-Dimethyl-2-isopropylpentanoic acid, 2,5-Dimethyl-2-ethylhexanoic acid, 2,2-Dimethyloctanoic acid, and/or 2,2-Diethylhexanoic acid. In preferred forms of the invention, the neodecanoic acid includes one or more compounds selected from the group consisting of those listed above.

In forms of the above embodiment, the organic diluent is immiscible with water.

In forms of the above embodiment, the organic diluent is one or more C10+ alkanes. Preferably, the organic diluent is one or more C11+ alkanes.

Most preferably, the organic diluent is one or more C12+ alkanes.

In forms of the above embodiment, the organic diluent includes one or more isoalkanes, one or more cycloalkanes, and mixtures thereof.

In an embodiment, the organic diluent includes, consists of, or consists essentially of one or more isoalkanes, one or more cycloalkanes, and mixtures thereof. In one example, the organic diluent includes, consists of, or consists essentially of one or more C10+ isoalkanes and/or one or more C10+ cycloalkanes. In preferred forms, the organic diluent includes, consists of, or consists essentially of one or more C11+ isoalkanes and/or one or more C11+ cycloalkanes. More preferably, the organic diluent includes, consists of, or consists essentially of one or more C12+ isoalkanes and/or one or more C12+ cycloalkanes.

In an embodiment the method includes nickel solvent extraction, wherein the nickel solvent extraction step includes:
(i) contacting an aqueous acidic nickel sulphate containing solution with an organic phase including an organic extractant to selectively extract nickel sulphate from the aqueous solution into the organic phase to form a nickel sulphate lean aqueous raffinate and the nickel rich organic phase; and
(ii) separating the raffinate and the nickel rich organic phase;
   wherein the organic extractant is one or more branched carboxylic acids.

In an alternative embodiment, the method includes nickel solvent extraction, wherein the nickel solvent extraction includes:
(i) a solvent extraction step including contacting an aqueous solution including nickel sulphate and one or more metal impurities with an organic phase, the organic phase including one or more branched carboxylic acid extractants to selectively facilitate the extraction of nickel sulphate from aqueous solution into the organic phase and form the nickel rich organic phase.

In an alternative embodiment, the method includes nickel solvent extraction, wherein the nickel solvent extraction step includes;
(i) contacting an aqueous nickel sulphate containing solution with an organic phase including an organic extractant to form the nickel rich organic phase, wherein the aqueous nickel sulphate containing solution is a pregnant leach solution (PLS).

This embodiment of the invention is described in the context of the PLS being a cobalt-lean nickel-rich raffinate.

In forms of the above mentioned embodiments, including an embodiment to be described in detail with reference to the present invention, the nickel sulphate containing solution is a pregnant leach solution derived from the high temperature pressure oxidation (HTPOX) of a nickel sulphide concentrate. As would be understood by the skilled person, ‘high temperature’ in this context is generally around 200° C., for example in the range of between about 190-230° C.

In alternative forms of the above mentioned embodiments that will be detailed below, the nickel sulphate containing solution is a pregnant leach solution derived from low temperature pressure oxidation (LTPOX) of a nickel sulphide concentrate. As would be understood by the skilled person, ‘low temperature’ in this context is generally around and below 100-120° C.

In forms of the above mentioned embodiments and alternative embodiments, the nickel sulphate containing solution is subjected to cobalt extraction prior to nickel solvent extraction, wherein the cobalt extraction step includes an organic extractant that selectively extracts cobalt over nickel into an organic phase to form a cobalt-rich nickel-lean extractant stream and a cobalt-lean nickel-rich raffinate. Preferably, the organic phase of the cobalt-rich nickel-lean extractant stream is converted to a cobalt-lean organic phase and the cobalt-lean organic phase is recycled as the organic phase or a component thereof.

In forms of the above mentioned embodiments and alternative embodiments, the nickel sulphate containing solution has been clarified prior to nickel solvent extraction. Preferably, the nickel sulphate containing solution has been clarified prior to being subjected to the cobalt extraction step.

In forms of the above mentioned embodiments and alternative embodiments, the nickel sulphate containing solution has been subjected to a secondary neutralisation step prior to nickel solvent extraction, wherein the secondary neutralisation step has been performed using one or more bases selected from the group including ammonium hydroxide, limestone, lime, calcrete, magnesia, magnesite and sodium hydroxide. Preferably, the nickel sulphate containing solution has been subjected to the secondary neutralisation step prior to being subjected to the cobalt extraction step. More preferably, the nickel sulphate containing solution has been subjected to the secondary neutralisation step prior to being clarified.

In forms of the above mentioned embodiments and alternative embodiments, the nickel sulphate containing solution has been subjected to a counter current decantation step prior to nickel solvent extraction. Preferably, the nickel sulphate containing solution has been subjected to the counter current decantation step prior to being subjected to the cobalt extraction step. More preferably, the nickel sulphate containing solution has been subjected to the counter current decantation step prior to being clarified. Even more preferably, the nickel sulphate containing solution has been subjected to the counter current decantation step prior to being subjected to the secondary neutralisation step.

In forms of the above mentioned embodiments and alternative embodiments, the nickel sulphate containing solution has been subjected a primary neutralisation step prior to nickel solvent extraction, wherein the primary neutralisation has been performed using one or more bases selected from the group including ammonium hydroxide, limestone, lime, calcrete, magnesia, magnesite and sodium hydroxide. Preferably, the nickel sulphate containing solution has been subjected to the primary neutralisation step prior to being subjected to the cobalt extraction step. More preferably, the nickel sulphate containing solution has been subjected to the primary neutralisation step prior to being clarified. Even more preferably, the nickel sulphate containing solution has been subjected to the primary neutralisation step prior to being subjected to the secondary neutralisation step. Yet more preferably, the nickel sulphate containing solution has been subjected to the primary neutralisation step prior to being subjected the counter current decantation step.

In forms of the above mentioned embodiments and alternative embodiments, the nickel sulphate containing solution is a PLS generated by a low temperature pressure oxidation (LTPOX) autoclave step on a nickel sulphide concentrate.

In forms of the above mentioned embodiments and alternative embodiments, the LTPOX autoclave step uses oxygen to oxidise the nickel sulphide of the nickel sulphide concentrate to nickel sulphate.

In forms of the above mentioned embodiments and alternative embodiments, the nickel sulphide concentrate contains more than 10% nickel.

In forms of the above mentioned embodiments and alternative embodiments, the nickel sulphide concentrate has been subjected to a fine grinding step, wherein the particles of the nickel sulphide concentrate are ground to a P80 of 10 microns.

In forms of the above mentioned embodiments and alternative embodiments, the nickel sulphide concentrate has been subjected to a repulping step prior to being subjected to the LTPOX autoclave step. Preferably, the nickel sulphide concentrate has been subjected to the repulping step prior being subjected to the fine grinding step.

In forms of the above embodiment and alternative embodiments, the nickel-rich organic phase is converted to a nickel-lean organic phase and the nickel-lean organic phase is recycled as the organic phase or a component thereof.

In forms of the above embodiments and alternative embodiments, the one or more bases are selected from the group including ammonium hydroxide, magnesia and sodium hydroxide are used in the nickel solvent extraction step; preferably ammonium hydroxide.

In forms of the above mentioned embodiments and alternative embodiments, the nickel lean organic phase is recycled as the organic phase or a component thereof.

In forms of the above mentioned embodiments and alternative embodiments, the organic phase includes, consists of, or consists essentially of an organic diluent and the organic extractant.

In an embodiment, the nickel rich organic phase includes: 5 ppm or less Fe and/or 5 ppm or less Mn and/or 5 ppm or less Cu and/or 60 ppm or less Co and/or 10 ppm or less Zn.

In an embodiment, the NiSO4·6H2O crystals include: 5 ppm or less Fe and/or 5 ppm or less Mn and/or 5 ppm or less Cu and/or 60 ppm or less Co and/or 10 ppm or less Zn.

In an embodiment, the one or more metal impurities are selected from the group consisting of: Fe, Mn, Cu, Co, Zn, and combinations thereof.

In an embodiment, the nickel lean organic phase contains substantially no nickel sulphate. By substantially no nickel sulphate, it is meant less than 10 ppm.

In an embodiment, the aqueous acidic nickel sulphate containing solution is a pregnant leach solution derived from the high temperature pressure oxidation of a nickel sulphide concentrate.

In an embodiment, the aqueous acidic nickel sulphate containing solution is a pregnant leach solution derived from the low temperature pressure oxidation of a nickel sulphide concentrate.

In an embodiment, the method may be carried out over a range of temperatures, for example a temperature of from about 10° C. to about 50° C.

Preferably, the method may be carried out at a temperature of from about 10° C. to about 40° C. However, advantageously, the method can be carried out at ambient temperature.

In a second aspect of the invention described in the Applicant's previous International Patent Application PCT/AU2019/051044 (WO 2020/061639), there are provided NiSO4·6H2O crystals produced according to the method of the first aspect of the invention.

Also disclosed therein is a method for recovering nickel sulphate from an aqueous acidic nickel sulphate containing solution including one or more impurities, the method including:
(i) contacting the aqueous acidic nickel sulphate containing solution with an organic phase including an organic extractant to selectively extract nickel sulphate from the aqueous solution into the organic phase to form a nickel sulphate lean aqueous raffinate and a nickel sulphate rich organic phase; and
(ii) separating the raffinate and the nickel sulphate rich organic phase;
   wherein the organic extractant is one or more branched carboxylic acids.

Further disclosed therein is a process for producing a purified nickel sulphate, the process including:
(i) a solvent extraction step including contacting an aqueous solution including nickel sulphate and one or more metal impurities with an organic phase, the organic phase including one or more branched carboxylic acid extractants to selectively facilitate the extraction of nickel sulphate from aqueous solution into the organic phase and form a nickel sulphate rich organic phase.

In a third aspect of the invention described in the Applicant's previous International Patent Application PCT/AU2019/051044 (WO 2020/061639), there is provided a method for recovering nickel sulphate, the method including:
(i) a low temperature pressure oxidation (LTPOX) autoclave step on a nickel sulphide concentrate, wherein the nickel sulphide concentrate contains more than 10% nickel.

In one embodiment of this aspect of that invention, the particles of the nickel sulphide concentrate are fine ground to a P80 of 10 microns.

In another embodiment, the LTPOX autoclave step uses oxygen to oxidise the nickel sulphide of the nickel sulphide concentrate to nickel sulphate.

In another embodiment, the method for recovering nickel sulphate further includes a primary neutralisation step using one or more bases selected from the group including ammonium hydroxide, limestone, lime, calcrete, magnesia, magnesite and sodium hydroxide. Preferably, the method further includes a secondary neutralisation step using one or more bases selected from the group including ammonium hydroxide, limestone, lime, calcrete, magnesia, magnesite and sodium hydroxide.

In a further embodiment, the method further includes a counter current decantation step, and preferably a secondary neutralisation step. The PLS of the second neutralisation step can be utilised in subsequent extraction steps. For example, in one embodiment, there is provided a cobalt solvent extraction step including an organic extractant that selectively extracts cobalt over nickel into an organic phase to form a cobalt-rich nickel-lean extractant stream and a cobalt-lean nickel-rich raffinate. Preferably, the organic phase of the cobalt-rich nickel-lean extractant stream is converted to a cobalt-lean organic phase and the cobalt-lean organic phase is recycled as the organic phase or a component thereof.

In an alternative embodiment, either the PLS product of the secondary neutralisation step, or the cobalt-lean nickel-rich raffinate is subjected to nickel solvent extraction and direct crystallisation steps. This embodiment of the invention is described in the context of a feed solution being cobalt-lean nickel-rich raffinate, wherein the nickel solvent extraction step includes;
(i) contacting the cobalt-lean nickel-rich raffinate with an organic phase including an organic extractant to form a nickel-rich organic phase; and
(ii) the direct crystallisation step includes contacting the nickel-rich organic phase with an aqueous strip solution of sufficient H2SO4 concentration to extract nickel from the organic phase and of sufficient Ni2+ concentration to precipitate NiSO4·6H2O crystals and form a nickel-lean organic phase.

In an alternative embodiment, the method further includes a nickel solvent extraction step wherein the cobalt-lean nickel-rich raffinate is contacted with an organic phase including an organic extractant to selectively extract nickel sulphate from the aqueous solution into the organic phase to form a nickel sulphate-lean aqueous raffinate and the nickel-rich organic phase; and
(i) separating the raffinate and the nickel-rich organic phase;
   wherein the organic extractant is one or more branched carboxylic acids.

In an alternative embodiment, the method further includes a nickel solvent extraction step that includes contacting a cobalt-lean nickel-rich raffinate and one or more metal impurities with an organic phase, the organic phase including one or more branched carboxylic acid extractants to selectively facilitate the extraction of nickel sulphate from aqueous solution into the organic phase and form the nickel-rich organic phase.

In the above aspects and embodiments of the invention, the one or more bases are selected from the group including ammonium hydroxide, magnesia and sodium hydroxide are used in the nickel solvent extraction step; preferably ammonium hydroxide.

In forms of the above embodiment and alternative embodiments, the nickel-rich organic phase is converted to a nickel-lean organic phase and the nickel-lean organic phase is recycled as the organic phase or a component thereof.

In a fourth aspect of the invention described in the Applicant's previous International Patent Application PCT/AU2019/051044 (WO 2020/061639), there is provided a method for producing nickel sulphate, the method including the steps of:
a) providing a source of nickel sulphide concentrate;
b) repulping the nickel sulphide concentrate;
c) fine grinding the nickel sulphide concentrate from step (b) to a P80 of 10 microns;
d) low temperature pressure oxidation (LTPOX) autoclaving of the nickel sulphide concentrate from step (c) to afford a pregnant leach solution (PLS), wherein the nickel sulphide concentrate contains more than 10% nickel;
e) neutralising the PLS using one or more bases selected from the group including ammonium hydroxide, limestone, lime, calcrete, magnesia, magnesite and sodium hydroxide;
f) counter current decantation of the PLS from step (e) to separate solids from the slurry of the PLS;
g) neutralising the PLS from step (f) using one or more bases selected from the group including ammonium hydroxide, limestone, lime, calcrete, magnesia, magnesite and sodium hydroxide;
h) optionally clarifying the PLS from step (g);
i) extracting cobalt from the PLS, wherein the cobalt extraction includes an organic extractant that selectively extracts cobalt over nickel into an organic phase to form a cobalt-rich nickel-lean extractant stream and a cobalt-lean nickel-rich raffinate;
j) extracting nickel from the cobalt-lean nickel-rich raffinate; wherein the nickel extraction includes contacting the cobalt-lean nickel-rich raffinate with an organic phase including an organic extractant to form a nickel-rich organic phase; and
k) direct crystallisation of the nickel-rich organic phase, wherein the direct crystallisation includes contacting the nickel-rich organic phase with an aqueous strip solution of sufficient H2SO4 concentration to extract nickel from the organic phase and of sufficient Ni2+ concentration to precipitate NiSO4·6H2O crystals and form a nickel-lean organic phase;
   wherein the nickel sulphate is between 21 and 24% nickel and is in the form of nickel sulphate hexahydrate (NiSO4·6H2O).

As detailed in the specification of the Applicant's previous International Patent Application PCT/AU2019/051044 (WO 2020/061639) and in Example 4 thereof, the concentration of H2SO4 that is ‘sufficient’ to extract nickel is relative to the nickel concentration. Typically, the H2SO4 strip solution will contain 10-450 g/L H2SO4; preferably 10-300 g/L and most preferably 10-20 g/L; and 80-100 g/L of Ni2+.

In an embodiment of the third or fourth aspects of the invention described in the Applicant's previous International Patent Application PCT/AU2019/051044 (WO 2020/061639), the nickel-rich organic phase includes: 5 ppm or less Fe and/or 5 ppm or less Mn and/or 5 ppm or less Cu and/or 60 ppm or less Co and/or 10 ppm or less Zn.

In a fifth aspect of the invention described in the Applicant's previous International Patent Application PCT/AU2019/051044 (WO 2020/061639) there is provided a method for producing a nickel sulphate containing solution, the method including:
(i) contacting a nickel-rich organic phase with an aqueous strip solution of sufficient H2SO4 concentration to extract nickel from the organic phase to form a nickel-lean organic phase.

In forms of any one of the first, third, fourth or fifth aspects of that invention, an ammonium sulphate by-product is recovered.

In a sixth aspect of the invention described in the Applicant's previous International Patent Application PCT/AU2019/051044 (WO 2020/061639) there is provided nickel sulphate produced according to the method of any one of the third, fourth or fifth aspects of that invention.

Further aspects of the invention described in the Applicant's previous International Patent Application PCT/AU2019/051044 (WO 2020/061639) and further embodiments of the aspects described in the preceding paragraphs will become apparent from the specification thereof, given by way of example and with reference to the accompanying drawings thereof.

As used herein with reference to described in the Applicant's previous International Patent Application PCT/AU2019/051044 (WO 2020/061639) of the present invention, except where the context requires otherwise, the terms ‘method’ and ‘process’ and variations of the terms, are used herein interchangeably and are not used in any instance to signify a difference between the terms.

P80 defines the product size of a slurry by the particle size at which 80% of the particles by mass are smaller than that particle size. Similarly, Px defines the product size of a slurry by the particle size at which x % of the particles by mass are smaller than that particle size.

PLS refers to a pregnant leach solution. Clarified PLS refers a pregnant leach solution where solids of the slurry have been removed, for instance, by counter current decantation. Herein, when referring to a PLS that is downstream of the removal of the suspended solids in the method of the invention, except where the context requires otherwise, reference to a PLS is equivalent to a clarified PLS.

Herein, various streams and phases of the invention are referred to as being either rich or lean in nickel and cobalt. When referring to streams and phases that form or are downstream of the cobalt solvent extraction and the nickel solvent extraction steps of the invention, a reference to a stream or phase being rich in either nickel or cobalt can be taken to mean that the stream or phase is lean in the other element, unless context requires otherwise. Similarly, when referring to streams and phases that form or are downstream of the cobalt solvent extraction and the nickel solvent extraction steps of the invention, a reference to a stream or phase being lean in either nickel or cobalt can be taken to mean that the stream or phase is rich in the other element, unless context requires otherwise.

As would be understood by the skilled person, enrichment and ‘rich’ in the context of this invention means that the relative concentration of the nickel or cobalt is higher than it was prior to being subjected to a previous step. For example, the PLS feedstock includes both cobalt and nickel. Application of a cobalt extraction process to a PLS feedstock generates a cobalt-lean nickel-rich raffinate, and a cobalt-rich nickel-lean extractant. The relative concentration of nickel and cobalt in the raffinate and extractant respectively is increased by at least 30%, at least 40%, at least 50%, at least 60%, at least 70%, at least 80% and at least 90% relative to the PLS feedstock. Similarly, a nickel rich organic phase has a higher relative amount of nickel than the feedstock/starting material from which it was derived, being increased by at least 30%, at least 40%, at least 50%, at least 60%, at least 70%, at least 80% or at least 90% relative.

The inverse is that ‘lean’ is understood to mean that nickel or cobalt has been depleted. Preferably at least 90%, at least 91%, at least 92%, at least 93%, at least 94%, at least 95%, at least 96%, at least 97%, at least 98% and at least 99% of the nickel or cobalt is removed to provide a lean phase. A lean phase preferably contains less than 20 ppm and more preferably less 10 ppm of nickel or cobalt.

The terms nickel sulphide concentrate and nickel/cobalt sulphide concentrate are used interchangeably herein, unless context requires otherwise.

As detailed in the specification of the Applicant's previous International Patent Application PCT/AU2019/051044 (WO 2020/061639) and in Example 4 thereof, the concentration of H2SO4 that is ‘sufficient’ to extract nickel is relative to the nickel concentration itself. Typically, the H2SO4 strip solution will contain 10-450 g/L H2SO4; most preferably 10-300 g/L. Sufficient Ni2+ concentration to precipitate is 80-100 g/L.

It is one object of the method of the present invention to provide a method for the preparation of a high-purity mixed nickel and cobalt sulphate and to provide a mixed nickel and cobalt sulphate produced by this method. In certain circumstances, including the use to which the product of the method of the invention will be put, it may be considered advantageous to provide a high-purity mixed nickel and cobalt sulphate rather than, as described in the Applicant's previous International Patent Application PCT/AU2019/051044 (WO 2020/061639), simply a high purity nickel sulphate, or high purity nickel sulphate hexahydrate, product. It is understood by the Applicants that the production of precursor cathode active materials (PCAM) need not require separation of nickel and cobalt. It is still further understood that it may be appropriate to retain a level of manganese in any feed for the production of PCAM. It is further understood by the Applicants that use of the crystallisation process as described in the Applicant's previous International Patent Application PCT/AU2019/051044 (WO 2020/061639) requires less energy than traditional or conventional crystallisation processes, and that it can be scaled to accommodate the nickel and cobalt production from specific mines.

As demand for lithium-ion batteries expands in line with increasing sales of electric vehicles and energy storage systems, so too does the demand increase for high-quality battery raw materials. Both nickel sulphate and cobalt sulphate are critically important in certain electric vehicle battery cathodes, particularly for battery technologies using nickel-cobalt-manganese (NCM) and nickel-cobalt-aluminium (NCA) cathode chemistries. NCM and NCA technologies are becoming increasingly popular given their high energy density which, in electric vehicle applications, results in longer driving range. There is also a transition to increased proportions of nickel in the cathode for both these battery types.

Typically, nickel sulphate is produced from intermediate or refined nickel products that have been subject to multiple complex metallurgical methods. These additional methods have resulted in nickel sulphate trading at a premium to the LME nickel metal price. The quantum of the premium is largely driven by market supply and demand, quality and provenance.

The methods of the invention optimises the production of both nickel and cobalt sulphate directly from nickel and cobalt containing sulphide concentrates without the requirement to first produce intermediary or refined products.

In addition, the methods of the invention are more environmentally sustainable compared to the traditional production methods for nickel and cobalt sulphate, due to the method's significantly lower emissions, power consumption and waste generation. In addition, the nickel and cobalt sulphate recovery methods of the invention are advantageous over traditional evaporative crystallisation methods performed at ambient or near ambient conditions as the methods of the invention are significantly faster.

The methods and processes of the invention also lead to other saleable by products including an elemental sulphur by-product.

It is appropriate to consider traditional solvent extraction technologies as they are implemented in hydrometallurgy. Typically, a metal bearing aqueous solution is exposed to an organic extractant. The metal bearing aqueous solution often carries more than a single metal, and the solvent extraction process is used to separate a desired metal from that aqueous solution.

The specific extractant employed can be used to select what metal to extract.

The aqueous solution is often a pregnant leach solution that may have resulted from an acid leach of an ore or concentrate bearing several metals, such as nickel, cobalt, iron, and aluminium. In such a case the pregnant leach solution will at least initially contain each of these metals. There are a variety of techniques available that may allow the separation of, and recovery of, these metals. These include manipulation of the pH of the aqueous pregnant leach solution that may remove the iron and aluminium through precipitation and filtering. The separation of the remaining metals may however require a more selective technique that can allow one of the remaining metals to be removed whilst leaving others in place. Solvent extraction is one such technique.

In a solvent extraction process cation exchange is employed. In the extraction step, in which the aqueous pregnant leach solution is contacted with the extractant compound in a mixer/settler, the target metal is exchanged with a hydrogen/proton of the organic extractant—producing what is termed a metal loaded organic phase. The metal loaded organic phase or extractant is then passed to a stripping step in which it is exposed, again in a mixer/settler, to an acid aqueous strip solution, such that the extractant is regenerated as the metal loaded thereon is transferred to the acid aqueous strip solution and the hydrogen/proton transferred back to the extractant. The strip solution with the entrained target metal is then passed to a separate process step in which the metal may be recovered, typically as a metal salt. For example, this separate process step is often a separate crystallisation step in which heat is applied to evaporate the solvent. Crystallisation of metal salts is generally not desired in convention solvent extraction/stripping circuits, hence the use of a separate process step, in separate equipment, for recovery of the metal salt.

It is known that mines located in remote locations, including in particular nickel mines, can be costly to service with reagents and labour. For example, the high purity of battery products and the need for specific trace analyses and specialty skills are difficult to resource in remote locations.

Precursor cathode active materials (PCAM) are a specialty chemical and to date the scale of vessels used in their production is much smaller than the volumes used in nickel sulphate production. A semi-finished intermediate can be solubilised to achieve a much higher nickel tenor at a “polishing refinery” than can be accommodated in most direct mineral extraction processes. Transportation of ores or concentrates to coastal and city locations is understood to add significant operating expenditure to any project.

Disposal costs of solid wastes and effluents generated during processing of ores and concentrates away from the original mine site can be problematic and costly.

The Applicants believe that locating the extraction facility at an existing mine site may provide significant advantages relative to the processing methods of the prior art. For example, the approvals processes are expected to be less onerous and the timeline to construction and production is expected to be shorter. It is to be understood that the specific advantages realised, and their quantum, will be dependent upon the specific locations in question.

The methods of the present invention have as one object thereof to overcome substantially one or more of the abovementioned problems of the prior art, or to at least provide useful alternatives thereto.

As used herein, except where the context requires otherwise, the term “comprise” and variations of the term, such as “comprising”, “comprises” and “comprised”, are not intended to exclude other additives, components, integers or steps. Comprising, except where the context requires otherwise, is used interchangeably with including.

P80 defines the product size of a slurry by the particle size at which 80% of the particles by mass are smaller than that particle size. Similarly, Px defines the product size of a slurry by the particle size at which x % of the particles by mass are smaller than that particle size.

PLS refers to a pregnant leach solution. Clarified PLS refers a pregnant leach solution where solids of the slurry have been removed, for instance, by counter current decantation. Herein, when referring to a PLS that is downstream of the removal of the suspended solids in the method of the invention, except where the context requires otherwise, reference to a PLS is equivalent to a clarified PLS.

Use of the term POX herein, which refers to pressure oxidation, is to be understood to refer to high temperature pressure oxidation or HTPOX, unless the context suggests or requires otherwise.

It is to be understood that the ranges provided herein include the stated range and any value or sub-range within the stated range. For example, a range from about 50 minutes to about 100 minutes, or about 50 to 100 minutes, should be interpreted to include not only the explicitly recited limits of from between from about 50 minutes to about 100 minutes, but also to include individual values, such as about 60 minutes, about 70 minutes, about 80 minutes, etc., and sub-ranges, such as from about 55 minutes to about 75 minutes, from about 65 minutes to about 95 minutes, etc. Furthermore, when “about” and/or “substantially” are/is utilised to describe a value, they are meant to encompass minor variations (up to +/−10%) from the stated value.

Each document, reference, patent application or patent cited in this text is expressly incorporated herein in their entirely by reference, which means that it should be read and considered by the reader as part of this text. That the document, reference, patent application, or patent cited in this text is not repeated in this text is merely for reasons of brevity.

Reference to cited material or information contained in the text should not be understood as a concession that the material or information was part of the common general knowledge or was known in Australia or any other country.

### DISCLOSURE OF THE INVENTION

In accordance with a first embodiment of the present invention there is provided a method for preparing high-purity mixed nickel and cobalt sulphate, the method comprising the recovery of nickel and cobalt sulphate crystals from an organic phase rich in both nickel and cobalt by way of contacting the nickel and cobalt rich organic phase with an aqueous strip solution of sufficient H2SO4 concentration to extract nickel and cobalt from the organic phase and of sufficient Ni²⁺ and Co²⁺ concentration to precipitate nickel and cobalt sulphate crystals and form a nickel and cobalt lean organic phase.

Preferably, the mixed nickel and cobalt sulphate crystals comprise nickel sulphate hexahydrate and cobalt sulphate heptahydrate, respectively.

Still preferably, the purity of mixed nickel and cobalt sulphate crystals prepared is such that the nickel to trace element ratio, excluding cobalt and manganese, is >20,000 times.

Preferably, the method further comprises separating the nickel and cobalt sulphate crystals from the nickel and cobalt lean organic phase.

Preferably, the aqueous strip solution:
(i) Comprises concentrated H2SO4; or
(ii) has an H2SO4 concentration of between 10 to 450 g/L.

Preferably, the nickel and cobalt rich organic includes a coordination complex of nickel and cobalt and an organic extractant, wherein the organic extractant dissociates from the nickel and cobalt in the presence of a sufficient concentration of H⁺ ions.

Still preferably, the organic extractant is selected from the group consisting of organophosphorous acids, chelating oximes or hydroxyoximes, carboxylic acids, and high molecular weight amines.

Preferably, the method further comprises a nickel and cobalt recovery step, wherein an aqueous acidic nickel and cobalt containing solution is contacted with an organic phase including an organic extractant selectively extract nickel and cobalt from the aqueous solution into the organic phase to form a nickel and cobalt lean aqueous raffinate and the nickel and cobalt rich organic phase, and separating the raffinate and the nickel and cobalt rich organic phase.

In one form, the aqueous acidic nickel and cobalt containing solution is:
(i) a pregnant leach solution;
(ii) a pregnant leach solution obtained from a leach of a sulphide ore or concentrate;
(iii) a pregnant leach solution obtained from a leach of a sulphide ore or concentrate and a mixed hydroxide precipitate.

Preferably, the aqueous acidic nickel and cobalt containing solution will have had at least a portion of any impurities present substantially removed therefrom prior to the nickel and cobalt recovery step. Such impurities may preferably include iron and aluminium.

Preferably, the method further comprises the recirculating of the aqueous strip solution, depleted in sulfuric acid, but containing relatively high Ni²⁺ and Co²⁺ concentrations, to ensure the solution saturation levels of the nickel sulphate hexahydrate and cobalt sulphate heptahydrate are exceeded with the addition of the fresh nickel and cobalt loaded organic phase.

In one form, the aqueous strip solution has a Ni²⁺ concentration of about 80-100 g/L and a Co²⁺ concentration of about 2-13 g/L, for example about 8-13 g/L.

The method may further comprise passing the nickel sulphate and cobalt sulphate crystals produced to a dissolution/repulping step.

Preferably, the dissolution/repulping step is conducted with high purity water.

Still preferably, from the dissolution/repulping step, a solution of the nickel sulphate and cobalt sulphate crystals is passed to a polishing step.

Yet still preferably, the purity of the solution from the polishing step is about 120 g/L nickel.

In one form, the mixed nickel sulphate and cobalt sulphate solution is utilised as feed for the production of PCAM.

In a further form, manganese sulphate is retained in the solution as feed for the production of PCAM.

In accordance with the present invention there is further provided a mixed nickel and cobalt sulphate produced by the method described hereinabove.

Preferably, the mixed nickel and cobalt sulphate produced by the method described above comprises nickel sulphate hexahydrate and cobalt sulphate heptahydrate.

In accordance with a second embodiment of the present invention there is further provided a method for the optimisation of feed for downstream processing, the method comprising the following method steps:
(i) Leaching an ore or concentrate at a first site to produce a pregnant leach solution containing one or more target metals;
(ii) Passing the pregnant leach solution to one or more impurity removal steps to produce an at least partially purified product;
(iii) Producing an intermediate product from the at least partially purified product from step (ii);
(iv) Transporting the intermediate product from step (iii) to a second site located remotely from the first site; and
(v) Conducting downstream processing of the intermediate product from step (iii) at the second site.

Preferably, the one or more target metals of step (i) include nickel and/or cobalt.

Still preferably, the one or more impurity removal steps of step (ii) comprise the precipitation of iron and aluminium.

Still further preferably, the one or more impurity removal steps of step (ii) further comprises an upgrade step. The upgrade step is preferably provided in the form of a solvent extraction step. The upgrade step still further preferably utilises a carboxylic acid extractant, for example Versatic 10™.

Preferably, step (iii) comprises the crystallisation of the intermediate product.

In one form of the present invention, step (iii) comprises the direct crystallisation of the intermediate product.

Preferably, the intermediate product of step (iii) is a metal sulphate intermediate.

Still preferably, the intermediate product of step (iii) is:
(i) an intermediate nickel sulphate; and/or
(ii) an intermediate cobalt sulphate.

In one form, the intermediate product of step (iii) further contains manganese sulphate.

The intermediate product is preferably produced in a manner that minimises its moisture content.

Preferably, the downstream processing of the intermediate product at the second site comprises one or more further impurity removal steps.

Still preferably, the further impurity removal steps comprise one or more ion exchange or solvent extraction steps.

In one form of the present invention the downstream processing of the intermediate product at the second site provides one or more precursor cathode active materials (PCAM).

The method of the second embodiment of the present invention, wherein the method steps thereof include the method of the first embodiment of the present invention as described hereinabove.

### DESCRIPTION OF THE DRAWINGS

The present invention will now be described, by way of example only, with reference to one embodiment thereof and the accompanying drawings, in which:—

FIG. 1 is a diagrammatic representation of a flowsheet incorporating a method for preparing high-purity mixed nickel and cobalt sulphate in accordance with the present invention.

### BEST MODE(S) FOR CARRYING OUT THE INVENTION

In accordance with a first embodiment, the present invention provides a method for preparing high-purity mixed nickel and cobalt sulphate, the method comprising the recovery of nickel and cobalt sulphate crystals from an organic phase rich in both nickel and cobalt by way of contacting the nickel and cobalt rich organic phase with an aqueous strip solution of sufficient H2SO4 concentration to extract nickel and cobalt from the organic phase and of sufficient Ni²⁺ and Co²⁺ concentration to precipitate nickel and cobalt sulphate crystals and form a nickel and cobalt lean organic phase.

In a preferred form of the present invention, the nickel sulphate crystals comprise nickel sulphate hexahydrate and are high purity as defined herein.

The present invention further provides a high-purity mixed nickel and cobalt sulphate produced by the method described herein. In a preferred form the mixed nickel and cobalt sulphate produced by the method described above comprises NiSO4·6H2O and CoSO4·7H2O.

The present invention still further provides a method and product intended for use in the production of precursor cathode active materials (PCAM).

In its broadest form, the present invention can be described with reference to the Applicant's previous International Patent Application PCT/AU2019/051044 (WO 2020/061639) but noting that rather than simply producing a crystallised nickel sulphate by way of a novel, direct crystallisation step, the present invention provides for the production of a crystallised nickel and cobalt sulphate by way of a novel, direct crystallisation step.

The methods of the present invention combine, for the first time, several technologies (both new and known) for use in the nickel and cobalt industry for the commercial integrated production of a nickel and cobalt sulphate product, one use for which is envisaged to be the production of PCAM.

The methods of the invention can be simplified into five sequential steps, as follows:
(i) Stage 1 Leaching: oxygen injection is used to partially oxidise a sulphide concentrate into soluble metal sulphate species (nickel, cobalt, copper, iron etc), sulphuric acid and sulphur.
(ii) Stage 2 MHP Leaching: exposure of a discharge slurry from Stage 1 Leaching to a mixed hydroxide precipitate (MHP) to solubilise additional metal species, including nickel and cobalt.
(iii) Stage 3 Neutralisation: A neutralisation stage for the removal of free acid, iron and aluminium to achieve the required feed solution for subsequent solvent extraction steps.
(iv) Stage 4 Impurity Removal Solvent Extraction and Precipitation: Zinc, manganese, calcium are removed from solution.
(v) Stage 5 Nickel and Cobalt Solvent Extraction and Crystallisation: Further impurities are removed from solution in the nickel and cobalt solvent extraction circuit before crystallisation by the novel, direct crystallisation method step.

This method may be incorporated directly into an overall method for the recovery of cobalt and nickel from a nickel/cobalt sulphide concentrate as described in an illustrative embodiment below.

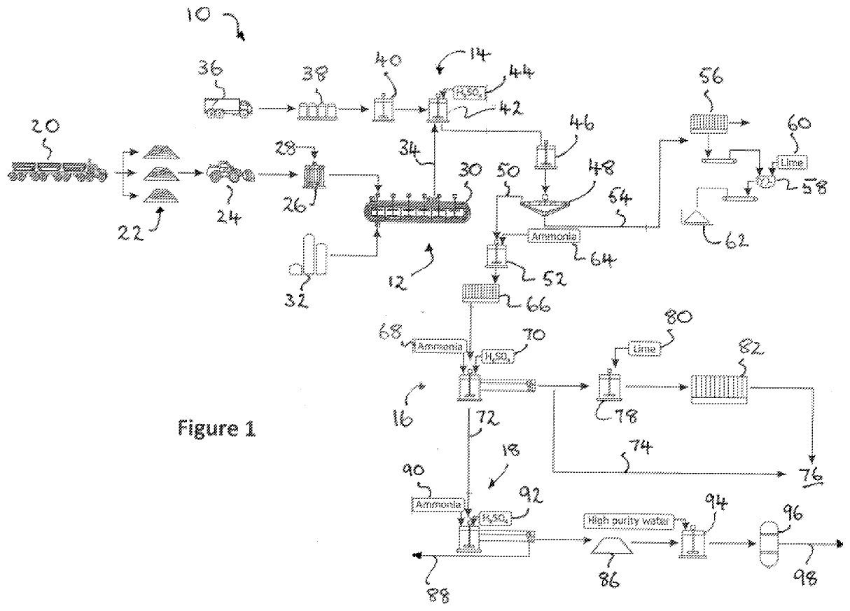

In FIG. 1 there is shown a method 10 for the optimisation of downstream processing, the method being an overall method for the recovery of cobalt and nickel from both a nickel and cobalt containing sulphide concentrate and a nickel and cobalt containing mixed hydroxide precipitate (MHP).

The method 10 comprises a first leach step 12, a second leach step 14, an impurity removal step 16 and a nickel and cobalt recovery step 18. The method 10 further comprises the passing of a nickel and cobalt containing sulphide concentrate 20 to a blending step 22, from which the blended concentrate is transferred 24 to a concentrate repulp step 26, in which the pulp density of the concentrate feed may be adjusted by repulping in water 28.

The first leach step 12 is a high temperature pressure oxidation leach (HTPOX) conducted in one or more autoclaves 30, the or each autoclave receiving repulped concentrate from the repulp step 26, and oxygen from an oxygen plant 32. The flow of repulped concentrate is provided to the or each autoclave at a solids flow rate of, in test work, between about 1.8 to 2.7 kg/hr, for example at about 2.1 kg/hr. Flow rates in a commercial facility can be expected to be much greater, for example about 15 to 17 tonnes per hour. The leach is conducted under conditions of increased pressure, for example at about 2500 kPa autoclave pressure, oxygen overpressure, for example between about 400 to 700 kPa oxygen, increased temperature of greater than about 200° C., for example about 210° C., and with an autoclave retention time of between about 40 to 70 minutes, for example about 70 minutes. The first leach step operates with an acid range of between 15 to 30 g/L sulphuric acid. The first leach step 12 produces an autoclave discharge slurry 34 that contains a significant level of sulphuric acid, for example about 24 g/L.

A mixed hydroxide precipitate 36 (MHP) is transported to storage 38, from where it passed to an MHP repulp step 40, before being passed to one or more vessels 42 at about 25% w/w solids, and a flow rate of between about 0.20 to 0.35 tonne MHP solids per tonne of sulphide concentrate (t/t), for example, about 0.22 tonne MHP solids per tonne of sulphide concentrate (t/t). The target for the process of the present invention is to provide approximately equal tonnes of nickel from concentrate and from MHP, and the ranges recited are dependent on the level of sulphide sulphur in the concentrate feed. The second leach step 14 is undertaken in the one or more vessels 42 at atmospheric pressure and at a temperature of about 80° C., with a retention time of about 70 to 100 minutes, for example between 78 and 97 minutes. The acid content of the autoclave discharge slurry 34 is largely utilised in the leaching of nickel and cobalt from the MHP fed thereto. The autoclave discharge slurry 34 is fed to the vessel 42 at a rate of, for example, about 17.42 kg/h in testing performed by the Applicants. Additional sulphuric acid 44 may be added to the second leach step 14 if considered necessary, to increase the amount of available acid that in turn allows additional MHP to be leached and without exceeding the target pH range of about 2.8 to 3.

The second leach step 14 generates a pregnant leach solution (PLS) at, for example, a pH of 3.5 and that contains, for example, about 50 g/L nickel, about 20 mg/L Fe(t) and about 20 mg/L Al. Residual free acid in the PLS is about 0.9 g/L.

From the second leach step 14 the pregnant leach solution is passed to a primary neutralisation step 46, and in turn to a counter current decantation step 48, from which an overflow 50 of pregnant leach solution is passed to an iron removal step 52, and an underflow 54 is passed to filtration 56 and neutralisation 58 with lime 60 prior to storage/disposal 62. The Applicants have found less than about 0.8% nickel present in the residue which is principally nickel associated with silicates reporting to the underflow 54.

In the iron removal step 52, comprising one or more tanks, anhydrous ammonia 64 is sparged into the pregnant leach solution to increase the pH to about 4.5 to 5, for example 4.75, and precipitate iron and aluminium. Precipitation efficiencies in the order of about 97.7% for iron and about 96.3% for aluminium have been realised in test work conducted by the Applicants. Further, iron and aluminium are, for example, each removed to levels of about <1 mg/L.

The iron removal step 52 operates in combination with a polishing filtration step 66 to which the nickel and cobalt containing pregnant leach solution is passed, and in which the precipitates generated in the iron removal step 52 are removed.

The pregnant leach solution from the polishing filtration step 66 is passed to the impurity removal step 16. The impurity removal step 16 comprises a solvent extraction process, for example operated in a counter-current array of mixer-settlers comprising 4 extracting, 3 scrubbing and 2 stripping stages, without inter-stage pH control. The organic phase is, for example, an organophosphoric extractant, which may in turn for example be Di(2-ethylhexyl)phosphoric acid (DEPHA), in an aliphatic diluent. Aqueous ammonia 68, for example at about 200 g/L, is used for neutralising stripped organic, dilute sulphuric acid 70 is used to scrub feed liquor at about 35 g/L and strip feed liquor at about 18 g/L.

The solvent extraction impurity removal step 16 is operated to provide a raffinate 72 that contains a minimal level of manganese, for example less than about 10 mg/L Mn. Near quantitative co-extraction of zinc, calcium and copper are also achieved. Gypsum 74 may be precipitated from stripping and passed to tails 76. Impurities are precipitated from the strip liquor in a precipitation stage 78 to which lime is added for pH modification, and removed in a subsequent filtration step 80.

The raffinate 72, rich in nickel and cobalt, is passed to the nickel and cobalt recovery step 18. The nickel and cobalt recovery step 18 comprises a solvent extraction process 84 in which a nickel and cobalt sulphate product 86 is directly crystallised and an ammonium sulphate containing raffinate 88 directed to a plant (not shown) by which an ammonium sulphate product (not shown) may be realised. The solvent extraction process 84 is operated in a counter-current array of mixer-settlers comprising, for example, 4 extracting, 3 scrubbing and 2 stripping stages, without inter-stage pH control. The organic phase is a carboxylic acid extractant, for example 40% Versatic 10™ in Vivasol™ diluent.

Aqueous ammonia 90, for example at about 200 g/L, is used for neutralising stripped organic, dilute sulphuric acid 92 is used to scrub feed liquor at about 35 g/L and strip feed liquor at about 18 g/L.

The nickel sulphate product amongst the nickel and cobalt sulphate product 86 is recovered as nickel sulphate hexahydrate, whereas the cobalt sulphate is recovered as cobalt sulphate heptahydrate. Crystallisation of both the nickel sulphate hexahydrate and cobalt sulphate heptahydrate is achieved by stripping the loaded organic phase with a sulphuric acid strip solution. The concentration of the sulphuric acid used to strip the nickel and cobalt from the loaded organic phase is not particularly important but is relative to the nickel and cobalt concentrations. The concentration of sulphuric acid used should be high enough to drive the stripping reaction to the right (e.g. the formation of NiSO₄·6H₂O and CoSO₄·7H₂O in the present case) and to ensure that the solubility product value of the nickel sulphate hexahydrate and cobalt sulphate heptahydrate 86 at the process conditions (for example, at the operating temperature) is exceeded and maintained during the stripping step. Typically, the sulphuric acid strip solution will contain concentrated (ie. 98%) H₂SO₄. But in an alternative embodiment, the sulphuric acid strip solution will contain 10-450 g/L H₂SO₄. In preferred forms, the process includes recirculating the strip solution (which is depleted in sulfuric acid) but includes high Ni²⁺ and Co²⁺ concentrations, typically of 80-100 g/L of Ni²⁺ and 2-13 g/L of Co²⁺, for example 8-13 g/L of Co²⁺, present to ensure the solution saturation levels of the nickel sulphate hexahydrate and cobalt sulphate heptahydrate is exceeded with the addition of the fresh nickel and cobalt loaded organic phase from the extraction process. The nickel and cobalt content is stripped as a more dense solid phase in the bottom of the solvent extraction mixer unit by addition of the sulphuric acid, from where it can be recovered by gravity/centrifuge and washing techniques as appropriate. Once the solid nickel sulphate hexahydrate and cobalt sulphate heptahydrate product is removed the essentially nickel and cobalt-free aqueous and organic phases are separated by conventional means, where the organic phase is recycled back to the solvent extraction process 18 with the aqueous stream being returned to upstream processes as part of the overall process water balance. The amount of sulfuric acid in the strip solution is dependent on the nickel and cobalt concentration of nickel and cobalt in the organic extractant phase.

The nickel sulphate and cobalt sulphate crystals 86 produced in the solvent extraction step 18 are passed to a dissolution/repulping step 94 in high purity water, after which they are passed to a polishing step 96. The polishing step 96 comprises one or more ion exchange (IX) steps that may, in one example, utilise a resin such as Lewatit® VP OC 1026 that is known to have high selectivity for iron and zinc over nickel and cobalt. Lewatit® TP 207 is another option known to the Applicants, with particular application in removal of trace copper. Alternatively, a solvent extraction step using D2EHPA, which contains the same active extractant reagent as the Lewatit® VP OC 1026 resin could be used. The polishing step 96 further comprises a polishing filter to substantially remove any entrained organic carbon.

The polishing step 96 provides a mixed nickel sulphate and cobalt sulphate solution 98 that may be utilised, in one application, as feed for the production of PCAM. The Applicants have envisaged that in one form of the invention manganese sulphate may also intentionally be present in the solution 98 as feed for the production of PCAM.

The target purity of the solution 98 is about 120 g/L nickel. Trace elements other than cobalt and manganese are intended to be controlled to levels at which the nickel to trace element ratio is >20,000 times.

The loading and stripping of the nickel and cobalt in the solvent extraction process 18 and crystallisation process can be carried out at or slightly above ambient temperature. By way of example, the temperature may be from ambient up to 50° C. However, no thermal energy input is generally required.

It is believed that this combined nickel and cobalt solvent extraction and crystallisation method of the present invention is the first development and implementation of such technology for making an ultra-pure (specialty chemical) nickel and cobalt containing product. The development of a purification and crystallisation (metal recovery) step into a single operation has, to the best of the knowledge of the or each inventor, not been achieved in the metal industry, let alone the nickel industry.

The inventors have also developed a method that allows high purity nickel sulphate and cobalt sulphate crystals to be prepared in an integrated method that seeks to generate a low cost and high purity nickel sulphate and cobalt sulphate product, and seeks to overcome one or more shortfalls of existing methods. Importantly, the methods of the invention differ significantly from Pressure Acid Leach (PAL) and High Pressure Acid Leach (HPAL) “whole of ore” prior art methods, which are both designed to treat nickel-cobalt rich lateritic ore. That said, the Applicants recognise that the methods of both the first and second embodiments of the present invention may be added to, or incorporated with, PAL and HPAL circuits to enhance laterite ore processing technologies, and both are considered to fall within the scope of the present invention.

In accordance with the second embodiment of the present invention, the present invention further provides a method for the optimisation of feed for downstream processing, wherein the method comprising the following method steps:
(i) Leaching an ore or concentrate at a first site to produce a pregnant leach solution containing one or more target metals;
(ii) Passing the pregnant leach solution to one or more impurity removal steps to produce an at least partially purified product;
(iii) Producing an intermediate product from the at least partially purified product from step (ii);
(iv) Transporting the intermediate product from step (iii) to a second site located remotely from the first site; and
(v) Conducting downstream processing of the intermediate product from step (iii) at the second site.

The first site is, in a preferred form of the present invention, at or very near the mine site from which an ore containing one or more target metals is produced. The one or more target metals of step (i) include nickel. In this form of the invention the ore or concentrate leached in step (i) is a nickel containing ore or concentrate.

The one or more impurity removal steps of step (ii) comprise the precipitation of iron and aluminium. The one or more impurity removal steps of step (ii) further comprises an upgrade step. The upgrade step is, in one form, provided as a solvent extraction step, utilising a carboxylic acid extractant, for example Versatic 10™.

Step (iii) comprises the crystallisation of the intermediate product. In one form of the present invention, step (iii) comprises the direct crystallisation of the intermediate product. This direct crystallisation provides an intermediate metal sulphate, for example a nickel sulphate, and is carried out in accordance with the process described in International Patent Application PCT/AU2019/051044 (WO 2020/061639), the entire content of which is explicitly incorporated herein by reference. Additionally, this direct crystallisation may be carried out in accordance with the first embodiment of the present invention, whereby the mixed nickel sulphate and cobalt sulphate produced therein may constitute the intermediate product.

The intermediate product is produced in a manner that minimises the moisture content, so as to avoid the transport of that moisture in step (iv).

The intermediate product of step (iii) is provided, for example, in the form of an intermediate nickel and cobalt sulphate. The downstream processing of the intermediate product at the second site comprises one or more further impurity removal steps, for example comprising one or more ion exchange steps, or alternatively solvent extraction steps. The downstream processing may further comprise an initial dissolution/repulping of sulphate crystals prior to passing to the one or more ion exchange steps. The downstream processing may still further comprise a polishing step whereby entrained organic carbon is removed.

In one form of the present invention the downstream processing of the intermediate product at the second site provides nickel and cobalt rich feed solutions for one or more precursor cathode active materials (PCAM). The PCAM may be transferred to a PCAM refinery for further processing.

The Applicants consider that the method of the first embodiment of the present invention may be undertaken in accordance with the method of the second embodiment of the present invention, wherein for example stages 1, 2, 3 and 5 are conducted at the first site, and stage 4 is conducted at the second site.

The method of the present invention, in accordance specifically with the first described embodiment thereof, may be further understood with reference to the following non-limiting example(s).

### EXAMPLES

A two-week continuous pilot plant campaign was operated using a plant that comprised the following integrated unit operations, as shown in FIG. 2:
1. Total high temperature pressure oxidation (POX, 210° C.) of a nickel sulphide flotation concentrate;
2. Leaching of an MHP in POX discharge slurry;
3. Solid-liquid separation and washing, comprising counter-current thickening and filtration;
4. Residual iron/aluminium precipitation using ammonia, providing a resultant pregnant leach solution (PLS).

The product liquor or pregnant leach solution was stored for subsequent treatment through solvent extraction (SX).

In addition, PLS produced in a separate campaign was processed through Impurity SX (ISX) where an organic containing DEHPA was used to extract Zn, Ca, Cu and Mn away from the contained Ni, Co and Mg. ISX raffinate was stored for recovery of contained Ni-Co in future campaigns.

### Nickel-Cobalt Deportment

A summary of the significant nickel and cobalt inputs/outputs for the campaign are set out below in Table 1.

Recovery of nickel from solid feeds to PLS was in excess of 98%. POX leach extractions were typically 97%, whilst that from MHP was approximately 100%. Soluble loss was <0.2% with scope for further reduction. As expected, cobalt recovery lagged nickel to some extent primarily due to lower POX extractions (94%) likely as a result of the lower cobalt head grade and closer association with iron (which is largely precipitated during POX).

[Remainder of page left blank intentionally]

TABLE 1
Nickel and Cobalt Deportment

| | | Solids | | | Liquor | | | Total | | Deportment | |
|---|---|---|---|---|---|---|---|---|---|---|---|
| | | Mass | Ni | Co | Volume | Ni | Co | Ni | Co | Ni | Co |
| | | kg | % w/w | % w/w | L | g/L | g/L | kg | kg | % | % |
| POX/MHP | Inputs | | | | | | | | | | |
| to PLS | Sulfide conc | 739 | 14.3 | 0.2 | | | | 105.9 | 1.8 | | |
| | MHP | 207 | 45.2 | 1.8 | | | | 93.7 | 3.8 | | |
| | Outputs | | | | | | | | | | |
| | Residue cake | 332 | 0.8 | 0.04 | 168 | 2.2 | 0.09 | 3.1 | 0.2 | 1.6% | 2.7% |
| | PLS | | | | 6252 | 31.4 | 0.87 | 196.5 | 5.4 | 98.4% | 97.3% |
| Impurity | Inputs | | | | | | | | | | |
| SX | PLS | | | | 3422 | 26.8 | 0.65 | 91.7 | 2.2 | | |
| | Outputs | | | | | | | | | | |
| | ISX Raffinate | | | | 3733 | 24.6 | 0.57 | 91.7 | 2.1 | 100% | 96.5% |
| | Strip product liquor | | | | 2836 | 0.010 | 0.028 | 0.0 | 0.1 | 0.03% | 3.5% |

For Impurity SX, nickel losses to the impurity strip product stream were negligible at 0.03%. Cobalt losses were higher and are governed by the Co-Mn selectivity of the DEHPA extractant. Cobalt losses have been reduced in subsequent testing with relaxation of manganese target levels with a view to making manganese available in the product as feed for PCAM production.

### POX to PLS Summary

A total of 739 kg of sulphide concentrate was processed during a continuous pilot plant campaign at an average rate of 2.3 kg/h. MHP addition to the POX residue was progressively increased across the campaign to elucidate both the chemistry impacts as well as the process economics. MHP input rate commenced at 0.20 t MHP solids per t sulphide concentrate solids (t/t) and were increased ultimately to 0.35 t/t.

POX treatment of the sulphide concentrate generated a discharge liquor containing 24 g/L H2SO4. This acid is able to be fully utilised to leach MHP at a rate of 0.22 t/t, representing an additional 70% nickel input over and above that contained in the sulphide concentrate solids. This input has several consequential economic benefits compared to stand-alone refining of either sulphide concentrate or MHP, as described below.

For stand-alone sulphide POX:
1. Elimination of the need for an alkali to neutralise POX discharge acid (typically limestone or ammonia);
2. Elimination of the reaction products associated with neutralisation (typically gypsum or ammonium sulphate) with consequent disposal costs and associated nickel losses;
3. Elimination of oxidant necessary to oxidise residual Fe(II) in POX discharge liquor (typically ˜1 g/L).

For stand-alone MHP refining:
1. Elimination of acid requirement for initial MHP input (up to 0.22 t/t);
2. Elimination of reductant necessary to achieve high Co (and Mn) leach extent.

This elegant synergy permits essentially complete dissolution of MHP in POX discharge slurry, whilst generating a liquor at pH 3.5 containing ˜50 g/L Ni, ˜20 mg/L Fe(t) and ˜20 mg/L Al. Low soluble iron levels significantly simplify downstream treatment.

It has been demonstrated that additional MHP input (up to 0.35 t/t) can be accommodated by way of input of fresh sulfuric acid to maintain slurry pH at <3.5. Acid consumption was as expected based on MHP composition, equating to ˜750 kg H₂SO₄ per t MHP solids.

Separation and washing of the solids leached residue was achieved in a four stage counter-current decantation circuit (CCD).

The solid and liquid phases in the neutralised leached slurry were separated using a counter-current array of thickeners (four stages) followed by filtration (three stage displacement wash). A wash ratio of ˜1.4 v/v was used across the filters equating to 1.1 v/v across the CCD's. Thickening performance was adequate achieving underflow solids content of 35-45% w/w with stage floc consumption of ˜50 g/t solids. Pressure filtration achieved filter cake solids content of 65-70% w/w. Overall nickel soluble loss was <0.2% with scope for further reduction.

CCD1 overflow liquor was treated with ammonia to precipitate remaining Fe and Al and generate PLS suitable for solvent extraction feed. Given the low level of Fe and Al present in this feed liquor, the duty on this circuit was extremely low. Fe and Al were consistently removed to <1 mg/L each with PLS neutralised to pH 4.5-5.0. Precipitated solids (21% Fe, 11% Ni, 0.1% Co) were removed in a thickener and recycled upstream to MHP leach for recovery of contained Ni and Co. Given the low mass flow of these solids the nickel recycle attributable to this stream is <0.5% (relative to total nickel in feed).

The average PLS grade across the campaign was 31 g/L Ni. However, for the last five days of pilot plant operation, as a result of both higher MHP input (0.35 t/t) and several water balance improvements, the average PLS grade was 36 g/L Ni. For this optimised period the full PLS composition is given in Table 2 below.

TABLE 2
Optimised PLS composition, Campaign 3A

| | PLS |
|---|---|
| | mg/L |
| Ni | 36252 |
| Co | 1015 |
| Cu | 443 |
| Zn | 165 |
| Fe | <1 |
| Al | <1 |
| Mn | 1375 |
| Mg | 7442 |
| Ca | 296 |

### Impurity SX Summary

A total of 3422 L of PLS was processed over this pilot plant campaign at an average rate of 10.4 L/h. Overall uptime for SX was 98% with operational performance generally stable as a result.

Impurity SX used an organic phase containing 20% v/v DEHPA in an aliphatic diluent. Mixer-settlers were used for all contacting duties arranged in a counter-current array comprising 4 extract, 3 scrub and 2 strip stages. Aqueous ammonia (200 g/L NH₃) was used for neutralisation of the stripped organic; dilute sulfuric acid was used for scrub feed liquor (35 g/L) and strip feed liquor (18 g/L). No inter-stage pH control was used.

The circuit was operated to achieve a raffinate of <10 mg/L Mn, with near complete co-extraction of Zn, Ca and Cu achieved. Co loss to strip was mitigated via scrubbing of the loaded organic, with scrub raffinate returned to extraction. Partial extraction of magnesium (˜10%) was consequential and can be reduced, if desired, through the use of additional extraction stages.

The strip circuit was operated to generate a strip product liquor at about 400 mg/L Ca to prevent gypsum precipitation. The Applicants envisage modifications to operation that will permit an approximately 90% reduction in strip product liquor volume.

The average composition of the Impurity SX feed and product liquors (PLS, raffinate, strip product) for the campaign are set out Table 3 below.

TABLE 3
Impurity SX feed/product stream composition, Campaign 3A

| | PLS | Raff | Strip Pr |
|---|---|---|---|
| | mg/L | mg/L | mg/L |
| Ni | 26802 | 24566 | 10 |
| Co | 649 | 574 | 28 |
| Cu | 448 | 11 | 526 |
| Zn | 98 | 0 | 118 |
| Mn | 775 | 3 | 932 |
| Ca | 305 | 7 | 359 |
| Mg | 7675 | 6397 | 842 |

### Direct Crystallisation of Mixed Nickel and Cobalt Sulphates

A sample of nickel sulphate and cobalt sulphate crystals produced in the solvent extraction step of the present invention (“Campaign 4”) was dissolved to achieve a 90-100 g/L Ni concentration. This solution sample was subject to assay of a full suite of elements by Inductively Coupled Plasma Mass Spectrometry (ICP-MS). The major elements were then also analysed using Inductively Coupled Plasma Optical Emission Spectroscopy (ICP-OES). These techniques facilitate highly accurate measurements of very low concentrations of trace elements in the dominant nickel sulphate solution matrix. The assay results are provided in Table 4 below.

TABLE 4
Major and Trace Element Assays for Mixed Nickel Sulphate and Cobalt Sulphate Intermediate Product
Full Element Assay Data for Dissolved Campaign 4 Crystals (Target to Achieve −95 g/L Nickel)

| Element | Co | Ni | Cu | Zn | Mn | Fe | As | Se | S | K |
|---|---|---|---|---|---|---|---|---|---|---|
| mg/l | 1694 | 94812 | 0.26 | 0.53 | 1.43 | 0.70 | 0.04 | 0.18 | 59437 | 0.99 |

| Element | Li | Be | B | Na | Mg | Al | Si | P | Pb | Bi |
|---|---|---|---|---|---|---|---|---|---|---|
| mg/l | 0.07 | <0.001 | 0.92 | 3.04 | 8.17 | 0.36 | 0.56 | 1.78 | 0.00 | <0.001 |

| Element | Ca | Sc | Ti | V | Cr | Rb | Sr | Hg | La | Ce |
|---|---|---|---|---|---|---|---|---|---|---|
| mg/l | 1.01 | 0.03 | 0.02 | <0.001 | <0.001 | <0.001 | <0.001 | 0.00 | 0.00 | 0.00 |

| Element | Nb | Mo | Cd | In | Sn | Sb | Cs | Ba | Th | U |
|---|---|---|---|---|---|---|---|---|---|---|
| mg/l | 0.03 | 0.03 | <0.001 | <0.001 | 0.01 | 0.04 | <0.0001 | <0.001 | <0.001 | <0.001 |

| Element | Dy | Ho | Er | Tm | Yb | Lu | Hf | Tl | Ga | Ge |
|---|---|---|---|---|---|---|---|---|---|---|
| mg/l | <0.0001 | <0.0001 | <0.0001 | <0.0001 | <0.0001 | <0.0001 | <0.0001 | <0.0001 | <0.001 | <0.001 |

| Element | Y | Zr | Pr | Nd | Sm | Eu | Gd | Tb |
|---|---|---|---|---|---|---|---|---|
| mg/l | 0.00 | 0.24 | 0.00 | 0.00 | <0.0001 | <0.0001 | <0.0001 | <0.0001 |

### Impurity SX (ISX) and Direct Crystallisation (NSX) Nickel and Cobalt Deportment

A summary of significant nickel and cobalt inputs/outputs for solvent extraction across campaign 4 is provided in Table 5 below. Importantly, results for the direct crystallisation of the mixed nickel and cobalt sulphate product, of the nickel and cobalt recovery step, are provided below.

TABLE 5
ISX and NSX Nickel and Cobalt Deportment

| | | Liquor | | | Total | | Department | |
|---|---|---|---|---|---|---|---|---|
| | | Volume | Ni | Co | Ni | Co | Ni | Co |
| | | L | g/L | g/L | kg | kg | % | % |
| Impurity SX | Inputs | | | | | | | |
| | ISX feed (PLS) | 2057 | 40.9 | 1.14 | 84.1 | 2.3 | | |
| | Outputs | | | | | | | |
| | ISX raffinate | 2167 | 88.8 | 1.08 | 84.1 | 2.3 | 100% | 99.7% |
| | Strip product liquor | 31 | 0.10 | 0.23 | 0.003 | 0.01 | 0.0% | 0.3% |
| Ni—Co | Inputs | | | | | | | |
| SX | ISX raffinate | 1564 | 39.3 | 1.1 | 61.5 | 1.7 | | |
| | Outputs | | | | | | | |
| | NSX raffinate | 2010 | 0.05 | 0.005 | 0.1 | 0.0 | 0.2% | 0.6% |
| | CS product liquor | 260 kg | 12.0% w/w | 0.28% w/w | 3.1 | 0.1 | 5.1% | 4.3% |
| | NS product solids | 288 | 20.3 | 0.6 | 58.3 | 1.6 | 94.8% | 95.1%% |

The composition of NSX feed and product streams for Campaign 4 is provided in Table 6 below.

TABLE 6
NSX Feed/Product Stream Compositions

| | PLS | Raff | CS aq | NS solids |
|---|---|---|---|---|
| | mg/L | mg/L | mg/L | g/t |
| Ni | 39316 | 46 | 11989 | 202573 |
| Co | 1094 | 5 | 282 | 4332 |
| Cu | 122 | 1 | 756 | <30 |
| Zn | 1 | 0 | 1 | <5 |
| Mn | 131 | 13 | 106 | <150 |
| Ca | 6 | 5 | 5 | <10 |
| Mg | 7260 | 5647 | 6 | <10 |

### Nickel and Cobalt SX (NSX)

A total of 1564 L of ISX raffinate was processed through NSX at an average rate of 7.8 L/h. NSX stability was the primary focus and steady state was achieved within an initial 12 h period and the average raffinate achieved for the balance of the campaign was 46 mg/L Ni with a typical range of 10 to 100 mg/L Ni. This represents a nickel loss to raffinate of only 0.2%.

Aside from nickel extraction, the other objective of NSX is to selectively reject Mg such that a desired Ni:Mg ratio in the sulphate crystal product (>20,000 w/w) is achieved. Ni:Mg ratios were progressively increased from ISX feed (Ni:Mg=5.4 w/w) to scrub stage 1 liquor (˜80), scrub stage 4 liquor (˜4000) and Strip stage 1 liquor (>10,000) across the campaign. This shows the progressive rejection of magnesium through the circuit and final levels are below that desired (>20,000 Ni:Mg in product liquor).

Cobalt reported with nickel to the crystal product with slightly higher losses due to the weaker extraction of cobalt by Versatic 10™ relative to nickel. It was noted that the cobalt concentration stabilised towards the end of the campaign at about 9 g/L. This represents a higher Ni:Co ratio than is evident earlier in the process and is thought to be due to minor selectivity in crystallisation of nickel over cobalt.

It was noted that copper is strongly extracted by Versatic 10™. This is addressed at one level through a selective strip process, in which 95% of nickel and cobalt was stripped in two stages at pH 4.0, along with <3% of the incoming copper. The remaining nickel and copper was stripped in three copper strip stages producing a concentrated nickel-copper stream (˜10 g/L Ni, ˜1.5 g/L Cu). It is envisaged by the Applicants that one of several available process options may be implemented for the recovery of the contained metal values in that stream. Copper remaining in the nickel and cobalt sulphate crystal product will be scavenged from the crystal product liquor using ion exchange (IX) with Lewatit® TP 207 resin.

Manganese extraction with Versatic 10™ is slightly weaker than that of cobalt, which in turn lags nickel. Manganese extraction in NSX was lower than that for nickel and cobalt at ˜87%. It is envisaged that manganese remaining in the nickel and cobalt sulphate crystal product can be scavenged from the crystal product liquor using IX with resins including Lewatit® OC1026 (containing D2EHPA) or TP220 (a cross-linked polystyrenic chelating resin), or may be retained to reduce the Mn make-up required prior to NCM PCAM production.

Unlike the conventional leaching philosophy for leaching of sulphides (or nickel sulphide concentrates), the Applicants have recognised the value of the whole feed concentrate and consider sulphide sulphur as an additional resource to be leached in addition to the nickel and cobalt values. Conventional thinking has always only looked to oxidise the sulphides that were associated with the pay or valuable metals, and have tried to minimise the leaching/conversion of any additional sulphides (non-base metal sulphide minerals) to sulphate ions. By rethinking the conventional theories and considering the other sulphides present as potential sulphuric acid sources the inventors have chosen to use the HTPOX technology to generate sulphuric acid that is used to leach an MHP and thereby increase the nickel and cobalt PLS tenors, to lower overall waste volumes such as the elemental sulphur volumes generated during LTPOX, and also lower the nickel and cobalt CAPEX intensity of the leaching operation.

It is envisaged that a high proportion, for example greater than 98%, of all waste and effluent streams and products from the processing method of the second embodiment of the present invention will be produced and handled at the first site. This is expected to reduce cost and may avoid stricter regulation in place at the second site.

It is further envisaged that processing of crystals, as proposed in step (v) of the second embodiment of the present invention, would be a cleaner operation than the processing of a fine precipitate (MHP) and won't suffer from impurities in entrained mother liquor and extra water washing. This should make this portion of the process of the second embodiment of the present invention more suitable for location in an urban or metropolitan industrial or light industrial setting.

The method of the present invention allows a high nickel tenor (˜100 g/L) solution to be fed forward to PCAM production, and there is expected to be no need to separate any cobalt present from nickel prior to finishing the contained metal as high quality PCAM products. Similarly, in some embodiments it is envisaged that manganese is also appropriate to retain in the solution to be fed forward to PCAM production.

The method of the present invention, separating geographically steps (i) to (iii) from step (v) as it does, is envisaged to provide the potential for reductions in capital expenditure (CAPEX) when compared with a process of the prior art that is typically located at a single site. This is considered to particularly be the case if that single site is located in an urban or even industrial setting. For example, an integrated facility located in a city location would in many jurisdictions be required to be fully enclosed, which adds additional CAPEX. The provision of steps (i) to (iii) at the first site, for example at a mine site, is expected to allow less CAPEX.

It is understood that an intermediate nickel sulphate produced in accordance with the present invention will have significantly lower levels of magnesium, chlorine, copper, zinc, manganese, calcium, and silicon impurities when compared with currently traded intermediate products, for example mixed hydroxide product (MHP) and mixed sulphate product. These impurities and hydroxides consume acid when further processed so require elimination. They add both CAPEX and OPEX wherever they are dealt with, with this being magnified if this is required to occur in an urban or metropolitan industrial or light industrial setting.

As can be seen with reference to the above description, the method of the second embodiment of the present invention avoids the transportation of ores or concentrates to coastal and/or urban or metropolitan industrial areas.

This method incorporates the transport of an intermediate product, which can be solubilised to provide a much higher nickel tenor relative to that possible in prior art extraction processes.

The forgoing description is to be considered non-limiting. Modifications and variations such as would be apparent to the skilled addressee are considered to fall within the scope of the present invention.

1. A method for preparing high-purity mixed nickel and cobalt sulphate, the method comprising recovery of nickel and cobalt sulphate crystals from an organic phase rich in both nickel and cobalt by way of contacting the nickel and cobalt rich organic phase with an aqueous strip solution of sufficient H₂SO₄ concentration to extract nickel and cobalt from the organic phase and of sufficient Ni²⁺ and Co²⁺ concentration to precipitate nickel and cobalt sulphate crystals and form a nickel and cobalt lean organic phase.

2. The method of claim 1, wherein the mixed nickel and cobalt sulphate crystals comprise nickel sulphate hexahydrate and cobalt sulphate heptahydrate, respectively.

3. The method of claim 1, wherein a purity of mixed nickel and cobalt sulphate crystals prepared is such that the nickel to trace element ratio, excluding cobalt and manganese, is >20,000 times.

4. The method of claim 1, wherein the method further comprises separating the nickel and cobalt sulphate crystals from the nickel and cobalt lean organic phase.

5. The method of claim 1, wherein the aqueous strip solution:
(i) comprises concentrated H₂SO₄; or
(ii) has an H₂SO₄ concentration of between 10 to 450 g/L.

6. The method of claim 1, wherein the nickel and cobalt rich organic phase includes a coordination complex of nickel and cobalt and an organic extractant, wherein the organic extractant dissociates from the nickel and cobalt in the presence of a sufficient concentration of H⁺ ions.

7. The method of claim 6, wherein the organic extractant is selected from the group consisting of organophosphorous acids, chelating oximes or hydroxyoximes, carboxylic acids, and high molecular weight amines.

8. The method of claim 1, wherein the method further comprises a nickel and cobalt recovery step, wherein an aqueous acidic nickel and cobalt containing solution is contacted with an organic phase including an organic extractant selectively extract nickel and cobalt from the aqueous solution into the organic phase to form a nickel and cobalt lean aqueous raffinate and the nickel and cobalt rich organic phase, and separating the raffinate and the nickel and cobalt rich organic phase.

9. The method of claim 8, wherein the aqueous acidic nickel and cobalt containing solution is:
(i) a pregnant leach solution;
(ii) a pregnant leach solution obtained from a leach of a sulphide ore or concentrate;
(iii) a pregnant leach solution obtained from a leach of a sulphide ore or concentrate and a mixed hydroxide precipitate.

10. The method of claim 8, wherein the aqueous acidic nickel and cobalt containing solution will have had at least a portion of any impurities present substantially removed therefrom prior to the nickel and cobalt recovery step.

11. The method of claim 10, wherein the impurities removed include iron and aluminium.

12. The method of claim 8, wherein the method further comprises recirculating of the aqueous strip solution, depleted in sulfuric acid, but containing relatively high Ni2+ and Co2+ concentrations, to ensure solution saturation levels of nickel sulphate hexahydrate and cobalt sulphate heptahydrate are exceeded with addition of fresh nickel and cobalt loaded organic phase.

13. The method of claim 12, wherein the aqueous strip solution has a Ni2+ concentration of about 80-100 g/L and a Co2+ concentration of:
(i) about 2-13 g/L; or
(ii) about 8-13 g/L.

14. The method of claim 1, wherein the method further comprises passing the nickel sulphate and cobalt sulphate crystals produced to a dissolution/repulping step.

15. The method of claim 14, wherein the dissolution/repulping step is conducted with high purity water.

16. The method of claim 14, wherein from the dissolution/repulping step, a solution of the nickel sulphate and cobalt sulphate crystals is passed to a polishing step.

17. The method of claim 16, wherein a purity of the solution from the polishing step is about 120 g/L nickel.

18. The method of claim 1, wherein the mixed nickel sulphate and cobalt sulphate solution is utilised as feed for the production of PCAM.

19. The method of claim 18, wherein manganese sulphate is retained in the mixed nickel sulphate and cobalt sulphate solution as feed for the production of PCAM.

20. A mixed nickel and cobalt sulphate produced by the method described in claim 1.

21.-33. (canceled)
